(19) United States
(12) Patent Application Publication
(10) Pub. No.: US 2014/0156256 A1
(43) Pub. Date: Jun. 5, 2014

(54) INTERFACE DEVICE FOR PROCESSING VOICE OF USER AND METHOD THEREOF

(71) Applicant: Electronics and Telecommunications Research Institute, Daejeon (KR)

(72) Inventors: Ki Hyun KIM, Daejeon (KR); Sang Hun KIM, Daejeon (KR); Seung YUN, Daejeon (KR)

(21) Appl. No.: 13/911,937

(22) Filed: Jun. 6, 2013

(30) Foreign Application Priority Data
Dec. 5, 2012 (KR) 10-2012-0140446

(51) Int. Cl. G06F 17/28

(52) U.S. Cl. CPC G06F 17/28
USPC 704/2

(57) ABSTRACT

The present invention suggests an interface device for processing a voice of a user which efficiently outputs various information so as to allow a user to contribute to the voice recognition or the automatic interpretation and a method thereof. For this purpose, the present invention suggests an interface device for processing a voice of a user which includes an utterance input unit configured to input utterance of a user, an utterance end recognizing unit configured to recognize the end of the input utterance; and an utterance result output unit configured to output at least one of a voice recognition result, a translation result, and an interpretation result of the ended utterance.

### CROSS-REFERENCE TO RELATED APPLICATIONS

This application claims priority to and the benefit of Korean Patent Application No. 10-2002-0140446 filed in the Korean Intellectual Property Office on Dec. 5, 2012, the entire contents of which are incorporated herein by reference.

### TECHNICAL FIELD

The present invention relates to an interface device for processing a voice and a method thereof. More specifically, the present invention relates to an interface device for processing a voice of a user and a method thereof for voice recognition or automatic interpretation.

### BACKGROUND ART

A user interface for voice recognition according to a related art recognizes a voice of one language on one window and then translates the voice to output a translated content on another window. In such a user interface, it is difficult to find a relationship between a content to be translated and a translated content. The user is not familiar with the user interface so that the user needs lots of time and effort to be used to the user interface and incorrect voice recognition and automatic interpretation result may be obtained in some cases.

The user interface according to the related art does not efficiently show various information for the voice recognition so that the user cannot more efficiently use voice recognition and automatic interpretation functions.

US Patent Application Publication No. 2009-0228273 discloses a user interface for voice recognition. However, US Patent Application Publication No. 2009-0228273 discloses a method that deducts a voice recognition result and then verifies the result to correct an error but it takes lots of time to deduct a final result without having an error.

### SUMMARY OF THE INVENTION

The present invention has been made in an effort to provide an interface device for processing a voice of a user which efficiently outputs various information to allow a user to contribute to the voice recognition or automatic interpretation and a method thereof.

However, the object of the present invention is not limited to the above description and other and further objects of the present invention will be more apparent to those skilled in the art in consideration of the following description.

An interface device for processing a voice of a user which includes an utterance input unit configured to input utterance of a user; an utterance end recognizing unit configured to recognize the end of the input utterance; and a utterance result output unit configured to output at least one of a voice recognition result, a translation result, and an interpretation result of the ended utterance.

The interface device for processing a voice of a user may further include voice volume level information output unit configured to output information on a voice volume level of the input utterance.

The voice volume level information output unit may output whether the voice volume level of the input utterance is appropriate on a picture or a graph using different colors or output an appropriate range of the voice volume level together with a current voice volume level of the input utterance.

The voice volume level information output unit may output the information on the voice volume level in real time.

The interface device for processing a voice of a user may further include a progress situation output unit configured to output at least one progress situation of a voice recognition progress situation, a translation progress situation, and an interpretation progress situation of the input utterance at a predetermined time using a character selected by the user, or an utterance start/end output unit configured to output the beginning of the utterance or the end of the utterance of the user.

The progress situation output unit may divide the input utterance into sentences and output any one of the voice recognition result, the translation result, and the interpretation result of the sentences as the progress situation.

If there are a plurality of the voice recognition results, a plurality of the translation results, and a plurality of the interpretation results, the utterance result output unit may previously output at least two results selected from the plurality of results and then finally output any one of the previously output results in accordance with the selection of the user.

When the translation result is output, the utterance result output unit may output the translation result with phonetic transcription of a native language of a user.

When the user inputs the end or when the utterance which is input for a predetermined period of time is not input any more, the utterance end recognizing unit may recognize that the utterance has ended.

The utterance result output unit may connect the input utterance and the result of the utterance to be output on one window.

The interface device for processing a voice of a user may be mounted in mobile equipment which is carried by the user.

An interface method of processing a voice of a user may include inputting utterance of a user; recognizing the end of the input utterance; and outputing at least one of a voice recognition result, a translation result, and an interpretation result of the ended utterance.

The interface method may further include outputting information on a voice volume level of the input utterance between the inputting of utterance and the recognizing of the end of the utterance.

The outputting of voice volume level information may include outputting whether the voice volume level of the input utterance is appropriate on a picture or a graph using different colors or outputting an appropriate range of the voice volume level together with a current voice volume level of the input utterance or outputting information on the volume level in real time.

The interface method may further include outputting at least one progress situation of a voice recognition progress situation, a translation progress situation, and an interpretation progress situation of the input utterance at every predetermined time using a character selected by the user between the inputting of utterance and the recognizing of the end of the utterance, or outputting the beginning of the utterance or the end of the utterance of the user before the inputting of the utterance or outputting the end of the utterance of the user after the recognizing of the end of the utterance.

The outputting of a progress situation may divide the input utterance into sentences and output any one of the voice recognition result, the translation result, and the interpretation result of the sentences as a progress situation.

If there are a plurality of the voice recognition results, a plurality of the translation results, and a plurality of the interpretation results, the outputting of an utterance result may previously output at least two selected from the plurality of results and then finally output any one of the previously output results in accordance with the selection of the user.

When the translation result is output, the outputting of an utterance result may output the translation result with phonetic transcription of a native language of the user.

The recognizing of the end of the utterance may recognize the end of the utterance when the user inputs the end or when the utterance which is input for a predetermined period of time is not input any more.

The outputting of an utterance result may connect the input utterance and the result of the utterance to be output on one window.

The interface method for processing a voice of a user may be performed in mobile equipment which is carried by the user.

The present invention may achieve the following effects:

First, the present invention provides a user interface which allows the user to contribute to the voice recognition to support a voice recognizing function with an improved accuracy.

Second, a situation for the voice recognition and interpretation in progress or an available situation is efficiently understood so that the user may easily use various and more accurate voice recognition and interpretation functions.

Third, if the user cannot directly access the other party or in an unexpected situation, the best alternative plan is used so that the user can use an automatic interpretation machine so that the applicability may be increased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating a voice recognition and automatic interpretation system according to an exemplary embodiment of the present invention.

FIG. 2 is a block diagram schematically illustrating an internal configuration of an interface device according to an exemplary embodiment of the present invention.

FIG. 3 is a detail view illustrating a sequence of processes and a flow of information throughout an entire process of the voice recognition (or automatic interpretation).

FIG. 4 is a detail view of a flow, a sequence, and actions of information between a user and a core engine from the beginning of the utterance to the end of the utterance during a voice recognition process in order to assist in the description of FIG. 3.

FIG. 5 is an exemplary view of a user interface which induces the outputting of information in accordance with the voice input and a behavior of the user in order to assist in the description of FIG. 4.

FIG. 6 is an exemplary view of a user interface which outputs information regarding voice recognized sentence and displays an available function in a current situation after finishing the voice recognition in order to assist in the description of FIG. 3.

FIG. 7 is another exemplary view of a user interface which displays an available function in the current situation in order to assist in the description of FIG. 3.

FIG. 8 is another exemplary view of a user interface which displays an available function in the current situation for automatically interpreted result in order to assist in the description of FIG. 3.

FIG. 9 is an exemplary view of a user interface which directly displays a phonetic symbol for the automatically interpreted sentence.

FIG. 10 is a flowchart schematically illustrating an interface method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In the figures, even though the parts are illustrated in different drawings, it should be understood that like reference numerals refer to the same or equivalent parts of the present invention. If it is considered that specific description of related known configuration or function may obscure the gist of the present invention, the detailed description will be omitted. Hereinafter, exemplary embodiments of the present invention will be described. However, it should be understood that a technical spirit of the present invention is not limited to the specific embodiments, but may be changed or modified by those skilled in the art.

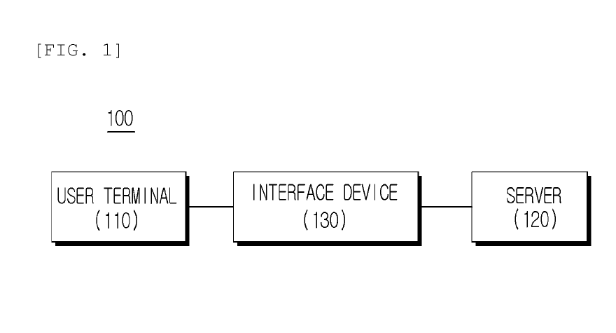

FIG. 1 is a block diagram schematically illustrating a system according to an exemplary embodiment of the present invention. Referring to FIG. 1, a system 100 includes a user terminal 110, a server 120, and an interface device 130.

The system 100 is a concept including a voice recognition system which is related to the voice recognition and a translation/interpretation system which is related to the translation or interpretation.

The user terminal 110 is a terminal which is carried or accessed by a user.

The server 120 is a concept including a voice recognition server which recognizes a voice of the user and a voice translation/interpretation server which translates or interprets the voice of the user.

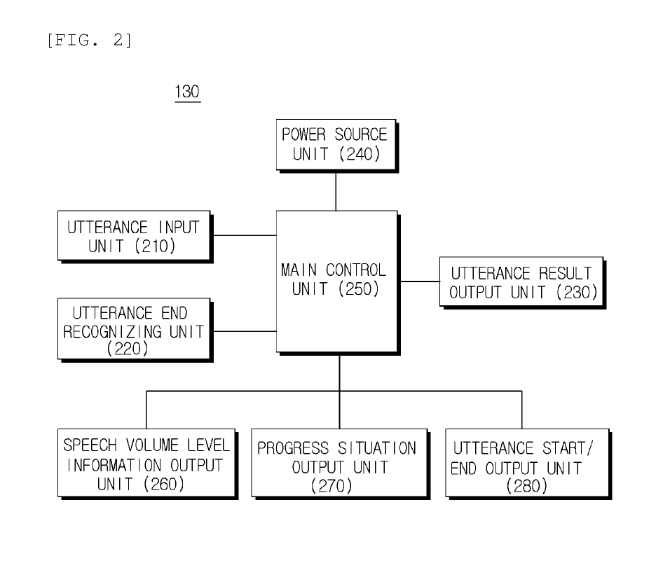

The interface device 130 outputs various information regarding the voice recognition, translation, and interpretation and functions to efficiently output various information so as to allow the user to contribute to the voice recognition or the automatic interpretation. Hereinafter, referring to FIG. 2, the interface device 130 will be described in more detail.

FIG. 2 is a block diagram schematically illustrating an internal configuration of an interface device according to an exemplary embodiment of the present invention. Referring to FIG. 2, the interface device 130 is a user voice processing device and includes an utterance input unit 210, an utterance end recognizing unit 220, an utterance result output unit 230, a power source unit 240, and a main control unit 250.

The interface device 130 is an interface for voice recognition which is used in portable mobile equipment such as a portable phone, a smart phone, a PDA, or a Laptop. In the present invention, the interface device 130 provides a user interface which leads the user to accurately recognize a voice in order to perform correct automatic interpretation and efficiently outputs a result of the voice recognition or the automatic interpretation or various information regarding the result to the user through a screen of mobile equipment so as to provide a result with a more improved accuracy than the related art.

The utterance input unit 210 inputs utterance of the user.

The utterance end recognizing unit 220 recognizes an end of the input utterance. When the user inputs the end or when the utterance which is input for a predetermined period of time is not input any more, the utterance end recognizing unit 220 may recognize that the utterance has ended.

The utterance result output unit 230 outputs at least one of a voice recognition result, a translation result, and an interpretation result of the ended utterance. If there are a plurality of the voice recognition results, a plurality of the translation results, and a plurality of the interpretation results, the utterance result output unit 230 may previously output at least two results selected from the plurality of results and then finally output any one of the previously output results in accordance with the selection of the user. When the translation result is output, the utterance result output unit 230 may output the translation result with phonetic transcription of a native language of the user. The utterance result output unit 230 may connect the input utterance and the result of the utterance to be output on one window.

The power source unit 240 supplies a power to each component of the interface device 130.

The main control unit 250 controls the overall operation of each component of the interface device 130.

The interface device 130 may further include at least one of a voice volume level information output unit 260, a progress situation output unit 270, and an utterance start/end output unit 280.

The voice volume level information output unit 260 outputs information on a voice volume level of the input utterance. The voice volume level information output unit 260 may output whether the voice volume level of the input utterance is appropriate on a picture or a graph using different colors or output an appropriate range of the voice volume level together with a current voice volume level of the input utterance. The voice volume level information output unit 260 may output the information on the voice volume level in real time.

The progress situation output unit 270 outputs at least one progress situation of a voice recognition progress situation, a translation progress situation, and an interpretation progress situation of the input utterance at every predetermined time using a character selected by the user. The progress situation output unit 270 may divide the input utterance into sentences and output any one of the voice recognition result, the translation result, and the interpretation result of the sentences as a progress situation.

The utterance start/end output unit 280 outputs the beginning of the utterance or the end of the utterance of the user.

Next, an exemplary embodiment of the system and the interface device illustrated in FIGS. 1 and 2 will be described. First, characteristics of the user interface according to the exemplary embodiment of the present invention are summarized as follows.

First, the user interface is configured to efficiently detect an end point, which is the most important object to increase the accuracy of the voice recognition, by a user.

Second, in order to assist the accurate voice recognition based on a voice volume level which is currently recognized, a voice is recorded at an appropriate voice volume level to be used for the voice recognition.

Third, a character which the user is familiar with explains the current voice recognition and an interpretation progress situation or an available situation to the user to assist the efficient voice recognition and automatic interpretation.

Fourth, plural translation results for a recognized sentence are efficiently output to provide various translation options to the user.

Fifth, automatic Korean phonetic conversion and display functions for the translated sentence are provided to assist the user to directly pronounce the sentence when the other party of the user cannot watch the screen or listen to the screen.

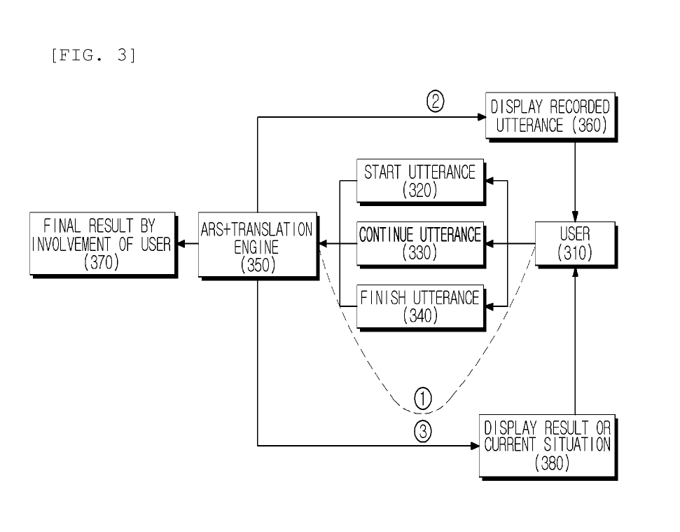

Hereinafter, the exemplary embodiment of the present invention will be described with respect to the above-described characteristics of the user interface. FIG. 3 is a detail view illustrating a sequence of processes and a flow of information throughout an entire process of the voice recognition (or automatic interpretation).

A user 310 starts utterance through the user interface and records the utterance (start utterance; 320). An ASR+translation engine 350 which receives a part of the recorded utterance displays the recorded utterance through the user interface (display recording Info; 360). In this case, the ASR+translation engine 350 displays information on end point detection or a voice volume level information (end point detection or voice volume level; 2).

Thereafter, the user continues utterance while controlling a background noise or a own voice based on the voice volume level information (continue utterance; 330). When the user finishes the utterance, the end of the utterance may be directly specified in accordance with the information of the display indicating that the utterance is completed (finish utterance; 340).

After finishing the utterance (340), the ASR+translation engine 350 which receives the entire recorded utterance generates the voice recognition result or the automatic interpretation result and displays the results (display result; 380). In the meantime, while continuing the utterance (330), the ASR+translation engine 350 which receives a part of the recorded utterance may display a current progress situation or an available situation with respect to an intermediate result of the voice recognition (status of recognition progress) or an intermediate result of the automatic interpretation (progress with other option; 380). Therefore, it is possible to obtain better voice recognition result or automatic interpretation result by the involvement of the user through the user interface (involving; (1)) (better result by involving; 370).

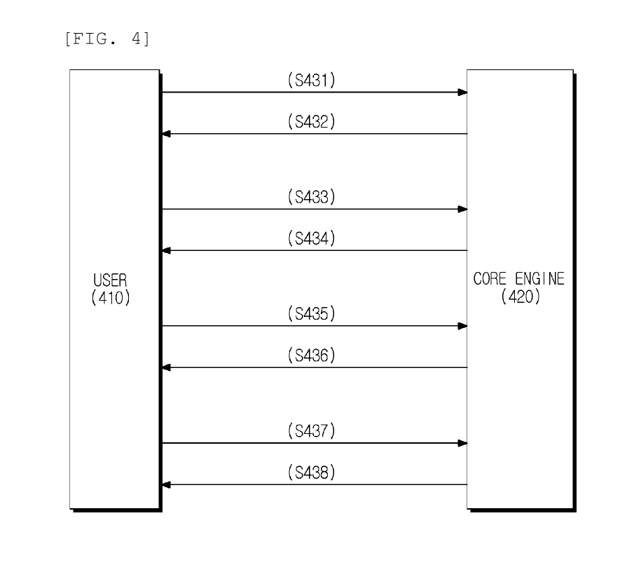

FIG. 4 is a detailed view of a flow, a sequence, and actions of information between a user and a core engine from the beginning of the utterance to the end of the utterance during a voice recognition process in order to assist in the description of FIG. 3. Referring to FIG. 4, the flow of information is listed from the top to the bottom in accordance with a time sequence.

The user 410 interacts with the core engine 420 in plural steps and deducts a voice recognition result (or automatic interpretation result) with an improved accuracy. The core engine 420 refers to a combined engine of an ASR engine, a context analyzer, and a translate engine.

When the user starts utterance (start utterance using microphone; S431), the core engine 420 detects the beginning of the utterance and notifies the user of the start and related information (detect and notify beginning of voice; S432). The user continues the utterance while appropriately controlling the situation based on the notified information (continue the utterance; S433) and the core engine 420 notifies the user of information (voice volume level) for the voice which is recorded from the continued utterance) (notify volume level of voice; S434). The user continues the utterance in accordance with the voice recognition based on the information. Finally, when the user finishes the utterance (finish the utterance: S435), the end of the utterance is detected and the user is notified that the end of the utterance is recognized (detect and notify end of voice; S436) and the user is leaded to be involved to finish the recording (finish the recording by user; S437). By doing this, the voice recognition result is shown to the user using an EPD (end point designation) specified by the user (auto voice recognition result based on the EPD by user; S438).

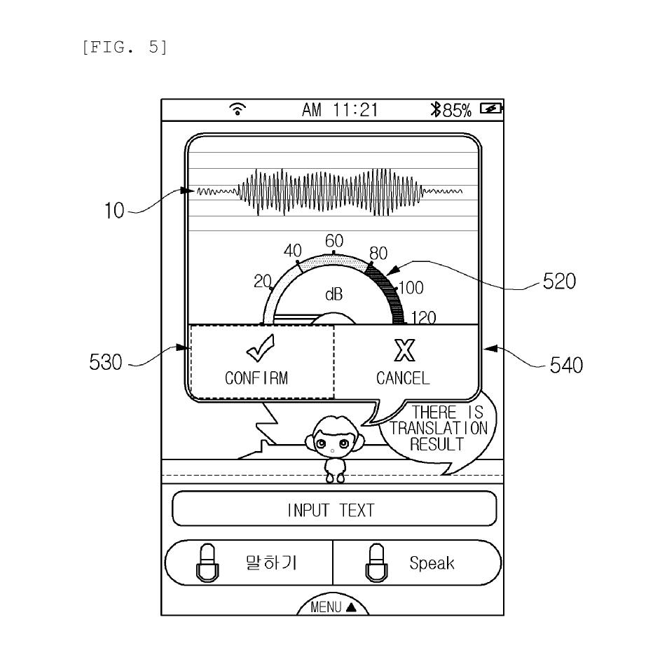

FIG. 5 is an exemplary view of a user interface which induces the outputting of information in accordance with the voice input and a behavior of the user in order to assist in the description of FIG. 4.

When a voice signal is received from the user, the input signal is displayed as a waveform (510) to notify the user that the input of the voice signal normally starts. A decibel value of the input voice signal is appropriately displayed using colors for the convenience of the user (520), so that a level of the voice signal is notified to the user to lead the user to appropriately input a voice. Finally, if it is detected that the inputting of the voice ends (or sometime around the end of the voice signal after starting the voice signal), the recording end button is repeatedly flickered (530) to the user to lead the user to finish the recording and detect the end point of the voice signal so that a better performance than that of the automatic end point detection is derived. During the voice recognition, the voice signal information is output and all components other than the user interface related with a voice recognition command are output to be dark (540) so as to lead the user to concentrate the voice recognition.

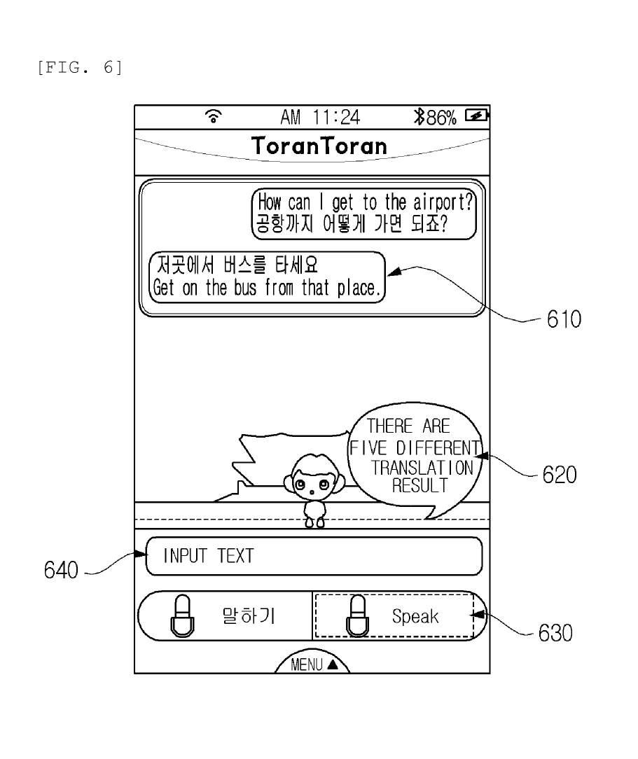

FIG. 6 is an exemplary view of a user interface which outputs information regarding voice recognized sentence and displays an available function in a current situation after finishing the voice recognition in order to assist in the description of FIG. 3.

A user interface which finds out a current context of the user to lead to an appropriate available subsequent situation is provided (610). First, information on a sentence which is finally recognized (or automatically interpreted) by the character and an available additional function are notified (620) to lead the user to use the function. Based on the information on the sentence which is finally recognized (or automatically interpreted), a voice recognition button for a language which is highly likely to be voice-recognized next is repeatedly flickered (630) so as to prevent the user from performing the voice recognition of wrong language. In order to notify the user that a text may be input when the voice recognition is not available, a user interface which induces the text input is configured (640).

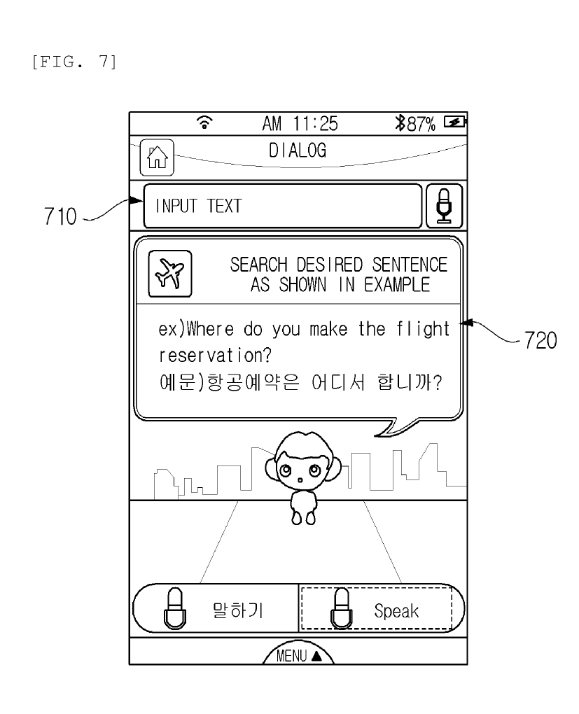

FIG. 7 is another exemplary view of a user interface which displays an available function in the current situation in order to assist in the description of FIG. 3.

A sentence is inserted in order to notify the user that the text input is also available in addition to the voice recognition and lead the user to input the text when the voice recognition is not available (710). The character may suggest an appropriate function in the current situation so that the user is led to directly use the function without any problem (720).

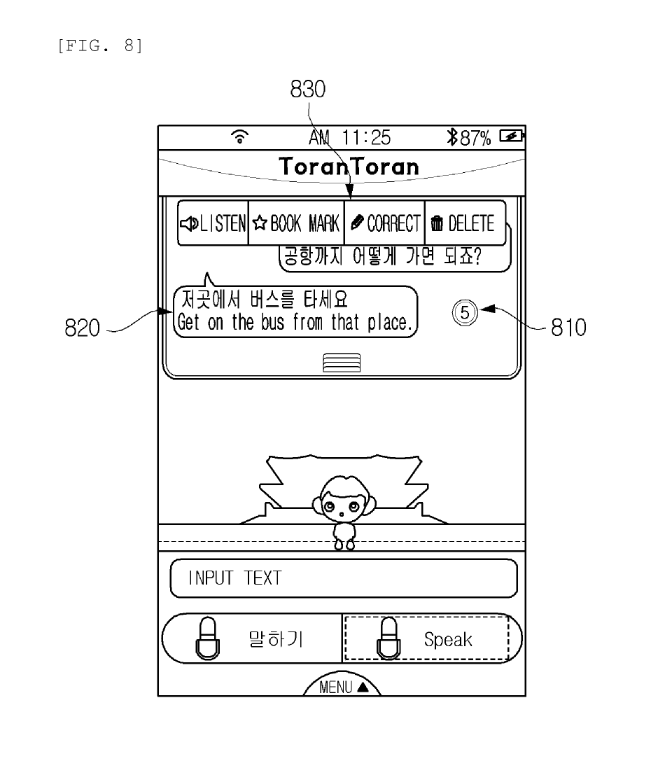

FIG. 8 is another exemplary view of a user interface which displays an available function in the current situation for the automatic interpretation result in order to assist in the description of FIG. 3.

An available additional function for a sentence which is primarily voice-recognized or completely automatically interpreted is displayed. In this example, the number of sentences similar to the recognized sentence is output next to the recognized sentence (810) so that the user is led to use the additional functions. The currently selected sentence is highlighted (820) to display the current progress situation so that the user notices the current progress situation. Additional available functions in the current situation (a situation where the voice recognition or the automatic interpretation is completed) are displayed so that the user proceeds to the next step (830).

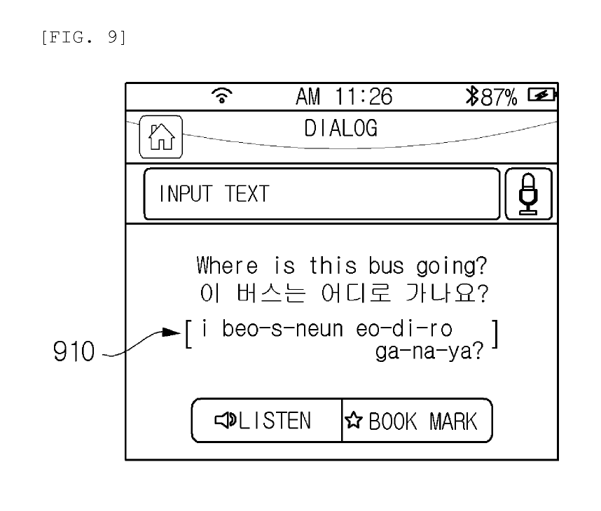

FIG. 9 is a exemplary view of a user interface which directly displays a phonetic symbol for the automatically interpreted sentence.

When TTS reproduction on the interpreted sentence is not available, the pronunciation of the sentence is represented by a language of the user (910) so that the user may pronounce the sentence without listening to the sentence.

The user interface which has been described in the above exemplary embodiment with reference to FIGS. 3 to 9 will be summarized as follows.

In a voice recognition system which includes a voice signal input unit which inputs a voice, a voice analyzing unit which processes and analyzes the input voice, and a voice recognizing unit which recognizes the voice with respect to the voice analysis result using a language model and a sound model, the voice recognition result which is a result of the voice recognizing unit is output (displayed) on mobile equipment.

In order to assist in the voice recognition in the voice signal input unit, the progress situation or available method or situation is output (displayed) on the mobile equipment.

Various secondary (translation or interpretation) results or availability of the voice recognition result are output (displayed) on the mobile equipment.

A pronouncing method for the translation and interpretation results is output (displayed) on the mobile equipment.

In order to assist the voice recognition in the voice signal input unit, a level (volume level) of the voice is output (displayed) on the mobile equipment.

An appropriate degree for the voice recognition in accordance with the level (volume level) of the voice is output (displayed) on the mobile equipment using a color, a graph, or a picture so as to be transmitted to the user.

A message according to the level (volume level) of the voice is listed in time sequence so that the appropriacy of entire utterance is output (displayed) on the mobile equipment.

In order to assist the voice recognition in the voice signal input unit, the progress situation and available method and situation of the voice recognition are output (displayed) on the mobile equipment.

The voice signal input unit recognizes that the voice signal of the user starts and ends to output (display) the recognition result on the mobile equipment.

A content or a picture which leads the user to perform a next behavior in accordance with the start point and the end point of the recognized voice signal is output (displayed) on the mobile equipment.

A method that obtains the voice recognition result, a method that utilizes the voice recognition result, and a function and a method which is appropriate or available in the current voice recognition or interpretation situation, and the current situation are calculated and a content or a picture which notifies the function and methods to the user is output (displayed) on the mobile equipment.

A character or a picture which the user is familiar with is output in the format of a voice bubble to output (display) a message to be delivered to the user on the mobile equipment.

The number of other results with respect to the voice recognition result or the translation (interpretation) result is output (displayed) on the mobile equipment.

A content or a picture which notifies a user of the number of other results with respect to the voice recognition result or the translation (interpretation) result as an available function is output (displayed) on the mobile equipment.

A function which converts the voice recognition result into an interrogative sentence or a declarative sentence is provided and is output (displayed) on the mobile equipment.

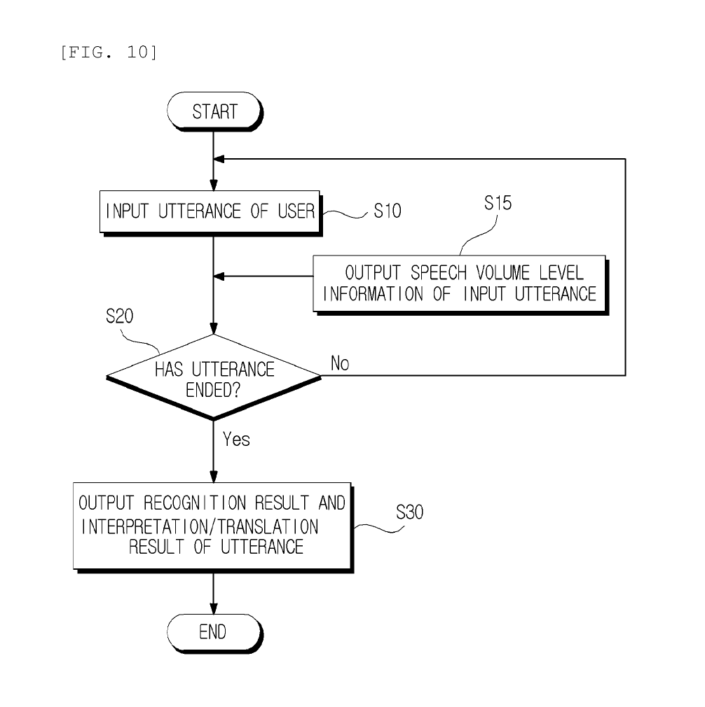

Next, an interface method of the interface device illustrated in FIG. 2 will be described. FIG. 10 is a flowchart schematically illustrating an interface method according to the exemplary embodiment of the present invention. The exemplary embodiment will be described below with reference to FIGS. 2 and 10.

First, in step S10, the utterance input unit 210 inputs utterance of a user. Before step S10, the utterance start/end output unit 280 may output the beginning of the utterance of the user.

After step S10, in step S15, the voice volume level information output unit 260 outputs information on a voice volume level of the input utterance. The voice volume level information output unit 260 may output whether the voice volume level of the input utterance is appropriate on a picture or a graph using different colors or output an appropriate range of the voice volume level together with a current voice volume level of the input utterance. The voice volume level information output unit 260 may output the information on the voice volume level in real time.

After step S15, in step S20, the utterance end recognizing unit 220 recognizes the end of the input utterance. When the user inputs the end or when the utterance which is input for a predetermined period of time is not input any more, the utterance end recognizing unit 220 may recognize that the utterance has ended. When it is recognized that the utterance is completed, the utterance start/end output unit 280 may output the end of the utterance of the user.

In step S20, if it is recognized that the utterance is completed, in step S30, the utterance result output unit 230 outputs at least one of a voice recognition result, a translation result, and an interpretation result of the completed utterance. If there are a plurality of the voice recognition results, a plurality of the translation results, and a plurality of the interpretation results, the utterance result output unit 230 may previously output at least two selected from the plurality of results and then finally output any one of the previously output results in accordance with the selection of the user. When the translation result is output, the utterance result output unit 230 may output the translation result with phonetic transcription of a native language of the user. In the meantime, the utterance result output unit 230 connects the input utterance and the result of the utterance to be output on one window.

Simultaneously to step S15, the progress situation output unit 270 may output at least one progress situation of a voice recognition progress situation, a translation progress situation, and an interpretation progress situation of the input utterance at every predetermined time using a character selected by the user. The progress situation output unit 270 may divide the input utterance into sentences and output any one of the voice recognition result, the translation result, and the interpretation result of the sentences as a progress situation. The steps which are performed by the progress situation output unit 270 may be performed between step S10 and step S15 or between step S15 and step S20.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An interface device for processing a voice of a user, comprising:
an utterance input unit configured to input utterance of a user;
an utterance end recognizing unit configured to recognize the end of the input utterance; and
an utterance result output unit configured to output at least one of a voice recognition result, a translation result, and an interpretation result of the ended utterance.

2. The interface device of claim 1, further comprising:
a voice volume level information output unit configured to output information on a voice volume level of the input utterance.

3. The interface device of claim 2, wherein the voice volume level information output unit outputs whether the voice volume level of the input utterance is appropriate on a picture or a graph using different colors or outputs an appropriate range of the voice volume level together with a current voice volume level of the input utterance.

4. The interface device of claim 3, wherein the voice volume level information output unit outputs the information on the voice volume level in real time.

5. The interface device of claim 1, further comprising:
a progress situation output unit configured to output at least one progress situation of a voice recognition progress situation, a translation progress situation, and an interpretation progress situation of the input utterance at every predetermined time using a character selected by the user, or
an utterance start/end output unit configured to output the beginning of the utterance or the end of the utterance of the user.

6. The interface device of claim 5, wherein the progress situation output unit divides the input utterance into sentences and outputs any one of the voice recognition result, the translation result, and the interpretation result of the sentences as the progress situation.

7. The interface device of claim 1, wherein if there are a plurality of the voice recognition results, a plurality of the translation results, and a plurality of the interpretation results, the utterance result output unit previously outputs at least two selected from the plurality of results and then finally outputs any one of the previously output results in accordance with the selection of the user.

8. The interface device of claim 1, wherein when the translation result is output, the utterance result output unit outputs the translation result with phonetic transcription of a native language of the user.

9. The interface device of claim 1, wherein when the user inputs the end or when the utterance which is input for a predetermined period of time is not input any more, the utterance end recognizing unit recognizes that the utterance has ended.

10. The interface device of claim 1, wherein the utterance result output unit connects the input utterance and the result of the utterance to be output on one window.

11. The interface device of claim 1, wherein the interface device for processing a voice of a user is mounted in mobile equipment which is carried by the user.

12. An interface method of processing a voice of a user, comprising:
inputting utterance of a user;
recognizing the end of the input utterance; and
outputing at least one of a voice recognition result, a translation result, and an interpretation result of the ended utterance.

13. The interface method of claim 12, further comprising:
outputting information on a voice volume level of the input utterance.

14. The interface method of claim 13, wherein the outputting of voice volume level information includes outputting whether the voice volume level of the input utterance is appropriate on a picture or a graph using different colors or outputting an appropriate range of the voice volume level together with a current voice volume level of the input utterance or outputting information on the volume level in real time.

15. The interface method of claim 12, further comprising:
outputting at least one progress situation of a voice recognition progress situation, a translation progress situation, and an interpretation progress situation of the input utterance at every predetermined time using a character selected by the user, or
outputting the beginning of the utterance or the end of the utterance of the user.

16. The interface method of claim 12, wherein if there are a plurality of the voice recognition results, a plurality of the translation results, and a plurality of the interpretation results, the outputting of utterance result previously outputs at least two selected from the plurality of results and then finally outputs any one of the previously output results in accordance with the selection of the user.

17. The interface method of claim 12, wherein when the translation result is output, the outputting of an utterance result outputs the translation result with phonetic transcription of a native language of the user.

18. The interface method of claim 12, wherein the outputting of an utterance result connects the input utterance and the result of the utterance to be output on one window.
